(19) United States
(12) Patent Application Publication
(10) Pub. No.: US 2025/0377004 A1
(43) Pub. Date: Dec. 11, 2025

(54) FURNITURE AND CONNECTION COMPONENTS

(71) Applicant: WALKER EDISON FURNITURE COMPANY LLC, WEST JORDAN, UT (US)

(72) Inventors: Murilo Tomaz, Piraquara Paraná (BR); Gisele Schneider, São Bento do Sul (BR); Marcio Guesser, Curitiba Parana (BR)

(21) Appl. No.: 18/734,205

(22) Filed: Jun. 5, 2024

(51) Int. Cl. F16B 12/20; F16B 12/46; F16B 13/02

(52) U.S. Cl. CPC F16B 12/20; F16B 12/46; F16B 13/02

(57) ABSTRACT

A connection component includes a body having a length and a plurality of sides. A one or more first connection features extend from a first side of the body and along the length of the body. The one or more first connection features have a dovetail profile. Second and third connection features extend from a second side of the body. The second and third connection feature are spaced apart posts.

### BACKGROUND

### 1. Technical Field

The present disclosure relates to furniture and connection components for connecting furniture parts together.

### 2. The Related Technology

Furnishing a space can require attention to a variety of different considerations. These considerations can include selecting furniture that fulfills required utilitarian functions or that provides a desired aesthetic. Other considerations may be the cost of the furniture. Still further, another consideration may be whether the furniture is pre-assembled or needs to be assembled by the user (i.e., “ready to assemble” or “RTA” furniture). Those that consider themselves to be less handy may be more likely to select pre-assembled furniture. However, RTA furniture is often less expensive than pre-assembled furniture. Accordingly, there is a need to create RTA furniture that can be easily and securely assembled.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

Exemplary embodiments of the present disclosure relate to furniture and connection components for connecting furniture parts together.

According to one embodiment, a connection component includes a body. A first connection feature extends from a first side of the body. A second connection feature extends from a second side of the body. The second connection feature is different than the first connection feature.

In another embodiment, a furniture kit includes a first wall, a second wall, and a connection component. The first wall has a dovetail groove formed therein. The second wall has one or more recesses formed therein. The connection component has a dovetail tongue and one or more posts. The dovetail tongue is configured for insertion into the dovetail groove to secure the connection component to the first wall. The one or more posts are configured for insertion into the one or more recesses to secure the connection component to the second wall.

In still yet another embodiment, a connection component includes a body and first, second, and third connection features. The body has a length and a plurality of sides. The first connection feature extends from a first side of the body and along the length of the body. The first connection feature has a dovetail profile. The second and third connection features extend from a second side of the body. The second and third connection features includes spaced apart posts.

In another embodiment, a connection component includes a body, first, second, and third connection features, an aperture, and a wedge. The body has a length and a plurality of sides. The first connection feature extends from a first side of the body and along a portion of the length of the body. The first connection feature has first and second wings that cooperate to form a dovetail profile. The second and third connection features extend from a second side of the body. The second and third connection features comprise spaced apart posts. The aperture extends through the body and between the first and second wings. The wedge is configured to be inserted into the aperture and between the first and second wings to cause the first and second wings to flex away from one another.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosed embodiments may be realized and obtained by means of the instruments and combinations particularly pointed out in the appended claims. Features of the disclosed embodiments will become more fully apparent from the following description and appended claims or may be learned by the practice of the disclosed embodiments as set forth hereinafter.

### BRIEF DESCRIPTION OF THE DRAWINGS

To further clarify the above and other advantages and features of the disclosed embodiments, a more particular description of the disclosed embodiments will be rendered by reference to specific embodiments thereof that are illustrated in the appended drawings. It is appreciated that these drawings depict only typical embodiments of the invention and are therefore not to be considered limiting of its scope. The disclosed embodiments will be described and explained with additional specificity and detail through the use of the accompanying drawings in which:

FIG. 1 illustrates parts of a drawer box and connection components that may be used to connect the drawer box parts together according to one example embodiment;

FIGS. 2-4 illustrate various views of a connection component according to one example embodiment;

FIG. 5 illustrates another connection component according to one example embodiment; and

FIGS. 6-11 illustrate an example process for assembling a drawer box using the components of FIG. 1.

FIGS. 12-15 illustrate various views of another connection component according to another example embodiment.

### DETAILED DESCRIPTION

The embodiments described herein extend to methods, devices, systems, assemblies, and apparatus relating to furniture and connection components for connecting furniture parts together. Such connection components are configured to, for example, allow for simple, quick, and solid assembly of furniture or parts (e.g., drawers, carcasses, etc.) thereof.

Reference will now be made to the drawings to describe various aspects of exemplary embodiments. It is understood that the drawings are diagrammatic and schematic representations of such exemplary embodiments, and are not limiting of the present invention, nor are any particular elements to be considered essential for all embodiments or that elements be assembled or manufactured in any particular order or manner. No inference should therefore be drawn from the drawings as to the necessity of any element. In the following description, numerous specific details are set forth in order to provide a thorough understanding of the disclosed embodiments. It will be obvious, however, to one of ordinary skill in the art that the disclosed embodiments may be practiced without these specific details. In other cases, well known aspects of furniture, furniture components, and general manufacturing techniques are not described in detail herein in order to avoid unnecessarily obscuring the novel aspects of the disclosed embodiments.

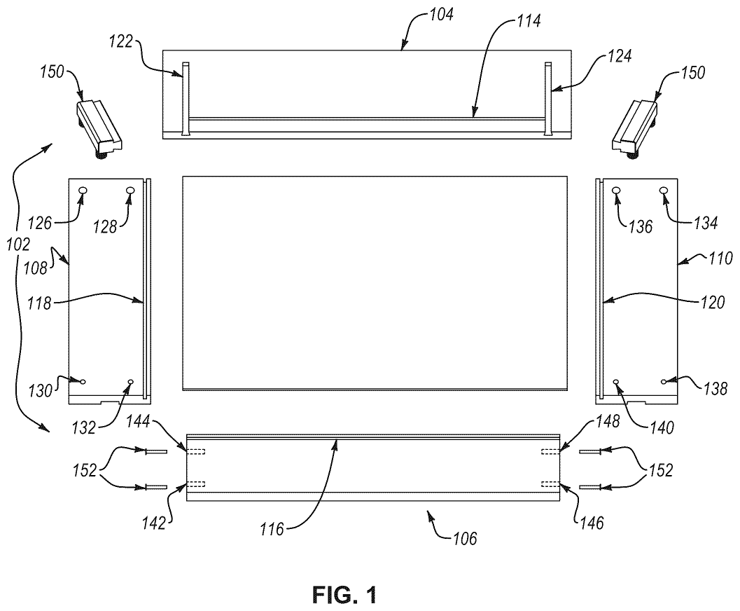

Attention is now directed to FIG. 1, which illustrates parts 100 of a drawer box (also referred to as “drawer box parts 100) and connection components 102 that may be used to connect the drawer box parts 100 together. Connecting the drawer box parts 100 together with the connection components 102 can form a drawer box that may be used in a dresser, table, cabinet, or the like.

In the illustrated embodiment, the drawer box parts 100 include a front wall 104, a back wall 106, a first side wall 108, a second side wall 110, and a bottom panel 112. The front wall 104, the back wall 106, the first side wall 108, and the second side wall 110 have grooves 114, 116, 118, 120, respectively, formed into interior surfaces thereof. The grooves 114, 116, 118, 120 may be sized to receive the edges of the bottom panel 112 therein. In the illustrated embodiment, the grooves 116, 118, 120 extend along the entire lengths of the back wall 106, the first side wall 108, and the second side wall 110 and open to opposing ends thereof. In the illustrated embodiment, the groove 114 extends along only a portion of the length of the front wall 104.

The drawer box parts 100 also include connection features that facilitate the connection of the parts 100 together. For instance, the front wall 104 includes dovetail grooves 122, 124 formed into the interior surface thereof. The dovetail grooves 122, 124 are spaced apart from one another, one adjacent to a first end of the front wall 104 and one adjacent to a second end of the front wall 104. In the illustrated embodiment, the dovetail grooves 122, 124 open to a bottom edge of the front wall 104 and extend towards a top edge of the front wall 104. In the illustrated embodiment, the groove 114 extends between the dovetail grooves 122, 124 but not beyond them.

The connection features in the first side wall 108 include first and second recesses 126, 128 formed into the interior surface thereof. In the illustrated embodiment, the first and second recesses 126, 128 are disposed towards a front end of the first side wall 108. The first and second recesses 126, 128 are arranged generally parallel to the first end of the first side wall 108. The connection features of the first side wall 108 may also include first and second apertures 130, 132 extending through the first side wall 108 between the interior surface and an exterior surface thereof.

The second side wall 110 may be a mirror image of the first side wall 108. For instance, the second side wall 110 may include similar or identical connection features as the first side wall 108, including first and second recesses 134, 136 and first and second apertures 138, 140.

The connection features of the back wall 106 may include first and second recesses 142, 144 (shown in dashed lines) extending into a first end of the back wall 106 and third and fourth recesses 146, 148 (shown in dashed lines) extending into a second end of the back wall 106. When the drawer box parts are being assembled, the first and second apertures 130, 132 and the first and second recesses 142, 144, respectively, can be aligned with one another and the first and second apertures 138, 140 and the third and fourth recesses 146, 148, respectively, can be aligned with one another.

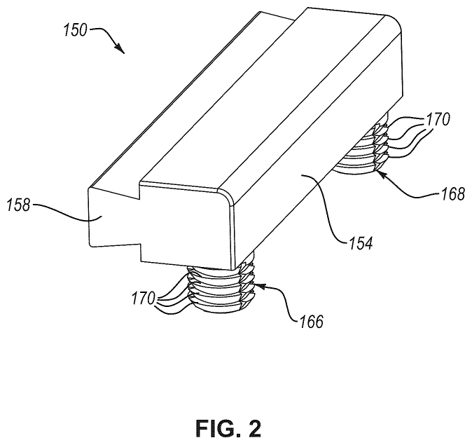

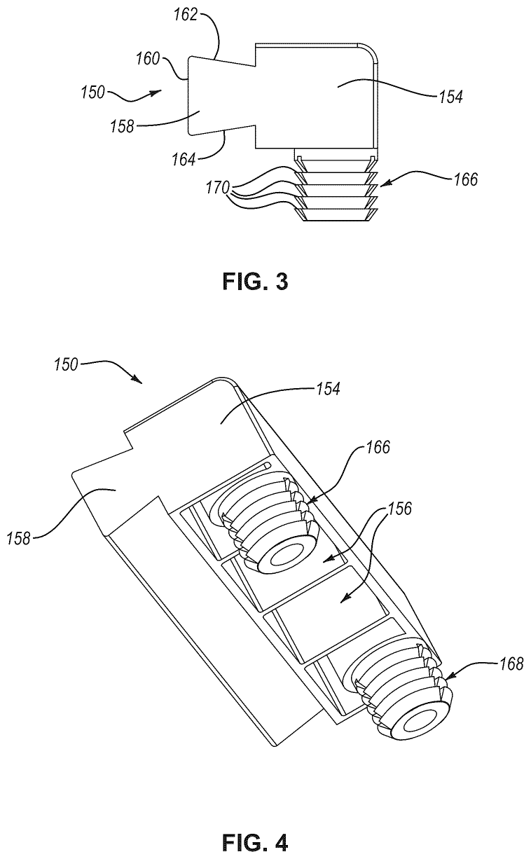

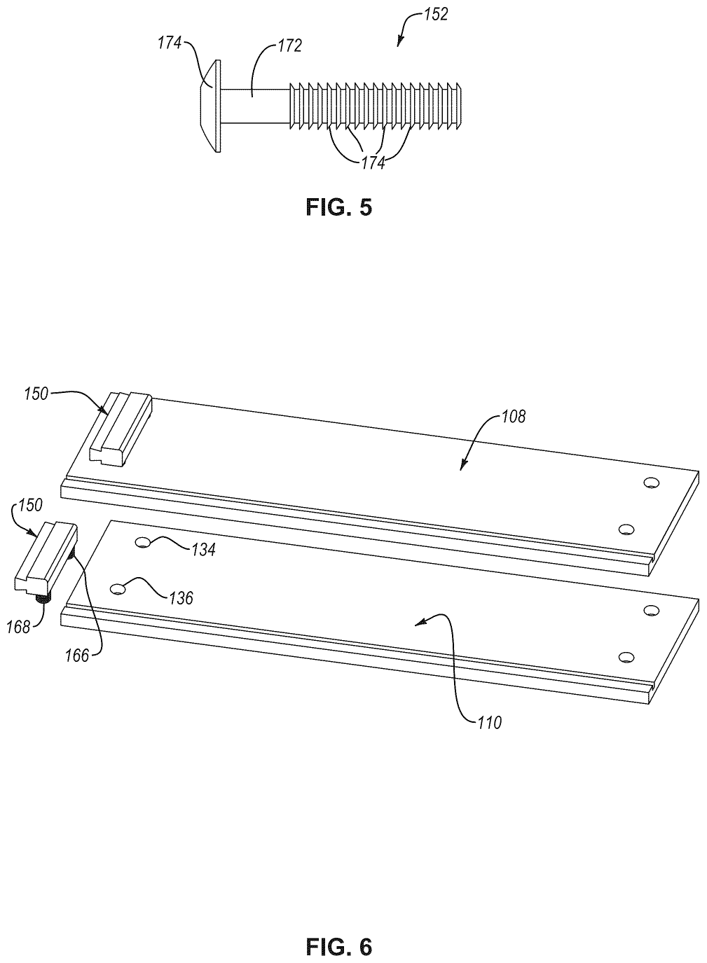

In the illustrated embodiment, the connection components 102 include two types of connection components. The first type of connection component is referred to as a dovetail connection component 150 and the second type of connection component is referred to as a pin connection component 152. An example embodiment of the dovetail connection component 150 is illustrated in FIGS. 2-4 and an example embodiment of the pin connection component 152 is illustrated in FIG. 5.

Attention is now directed to FIG. 2-4. As illustrated, the dovetail connection component 150 includes a body 154. In the illustrated embodiment, the body 154 has a generally rectangular elongated shape. As shown in FIG. 4, the body 154 may include one or more cavities 156 form therein. The cavities 156 may reduce the weight of the body 154 and reduce the amount of material required to form the body 154.

The dovetail connection component 150 may include two or more connection features that are configured to connect to the drawer box parts 100 together. In the illustrated embodiment, the connection features include a dovetail tongue 158 extending from a first side of the body 154. The dovetail tongue 158 extends along at least a portion of the length of the body 154. The dovetail tongue 158 includes a face 160 and sidewalls 162, 164. The sidewalls 162, 164 are slanted relative to one another, such that the ends of the sidewalls 162, 164 adjacent to the face 160 are further apart from one another than the ends of the sidewalls 162, 164 adjacent to the body 154. The dovetail tongue 158 is sized and shaped to fit within dovetail grooves 122, 124 in the front wall 104 to secure the dovetail connection component 150 to the front wall 104.

The dovetail connection component 150 also includes one or more second connection features extending from a second side of the body 154. In the illustrated embodiment, the second connection features include posts 166, 168. As illustrated, the posts 166, 168 are disposed adjacent to opposing ends of the dovetail connection component 150. The spacing between the posts 166, 168 may correspond to the spacing between the recesses 126, 128, 134, 136.

In the illustrated embodiment, the posts 166, 168 have generally cylindrical shapes, although other shapes are contemplated. In some embodiments, including the illustrated embodiment, the posts 166, 168 may include ribs 170 disposed at least partially therearound and along at least a portion of the length thereof.

The posts 166, 168 may be sized and shaped so they can be inserted into the recesses 126, 128, 134, 136 in the side walls 108, 110. In some embodiments, the size and shape of the posts 166, 168 may correspond to the size and shape of the recesses 126, 128, 134, 136 in the side walls 108, 110. In any event, the posts 166, 168 may be inserted into the recesses 126, 128, 134, 136 to secure the dovetail connection component 150 to the first or second side walls 108, 110. The posts 166, 168 and the recesses 126, 128, 134, 136 may create a friction fit that securely holds the posts 166, 168 in the recesses 126, 128, 134, 136. The ribs 170 on the post 166, 168 may facilitate insertion of the posts 166, 168 into the recesses 126, 128, 134, 136 while resisting withdrawal of the posts 166, 168 therefrom. For instance, the ribs 170 may be angled, slanted, or otherwise configured to facilitate insertion and resist withdrawal from the recesses.

In the illustrated embodiment, the dovetail tongue 158 and the posts 166, 168 extend from the body 154 or sides thereof at an angle relative to one another. In the illustrated embodiment, the dovetail tongue 158 extends from the body 154 in a first direction and the posts 166, 168 extend from the body 154 in a second direction, where the first and second directions are at an angle of about 90 degrees.

Attention is now directed to FIG. 5, which illustrates and example embodiment of a pin connection component 152. As illustrated, the pin connection component 152 includes a shaft 172 and a head 174 disposed at one end of the shaft 172. The head 174 has a larger diameter than the shaft 172. In some embodiments, including the illustrated embodiment, at least a portion of the length of the shaft 172 includes ribs 176 disposed at least partially therearound. The shaft 172 is configured to be inserted through one of the apertures 130, 132, 138, 140 and into the corresponding recess 142, 144, 146, 148. The head 174 may engage the exterior surface of the side wall 108, 110 and the shaft 172 and the recess 142, 144, 146, or 148 may create a friction fit. The friction fit between the shaft and the recess 142, 144, 146, or 148 and the engagement of the head 174 with the exterior surface of the sidewall 108, 110 may secure the sidewall 108, 110 and the back wall 106 together. In some embodiments, the ribs 176 may be angled, slanted, or otherwise configured to facilitate insertion and resist withdrawal from the recesses.

Attention is now directed to FIGS. 6-11, which illustrate example steps of assembling a drawer using the drawer box components 100 and connection components 102. Although the steps are illustrated and described is a particular order, it will be appreciated that the ordering of the steps may be varied from one embodiment to another.

As shown in FIG. 6, a dovetail connection component 150 can be connected to each of the side walls 108, 110. This can be done by inserting the posts 166, 168 of a dovetail connection component 150 into the recesses in the corresponding side wall. In the illustrated embodiment, a dovetail connection component 150 has already been secure to the first side wall 108 by inserting the posts 166, 168 thereon into the first and second recesses 126, 128. The other dovetail connection component 150 may similarly be secured to the second side wall 110 by inserting the posts 166, 168 thereon into the first and second recesses 136, 136.

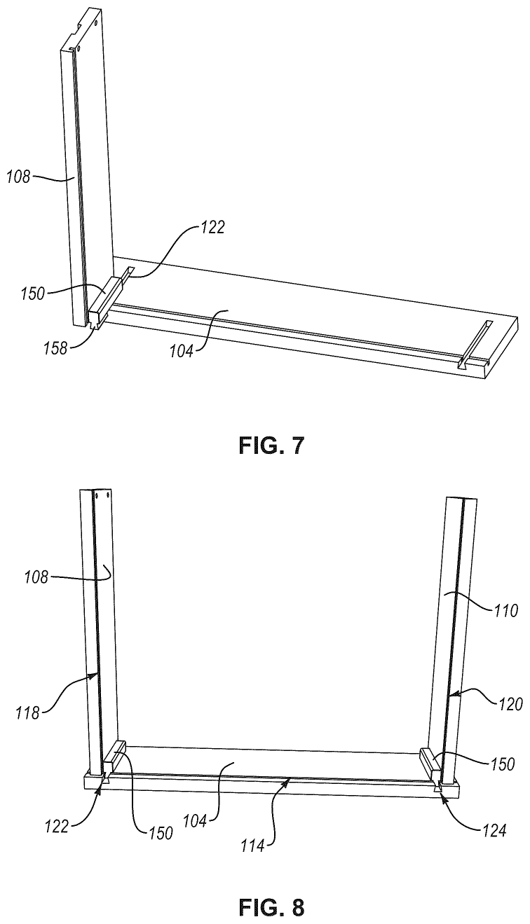

With the dovetail connection components 150 connected to the first and second side walls 108, 110, the first and second side walls 108, 100 can be connected to the from wall 104. This can be done by connecting the dovetail connection components 150 to the front wall 104 with the dovetail tongues 158 and the dovetail grooves 122, 124. More specifically, as shown in FIG. 7, the dovetail tongue 158 associated with the first side wall 108 can be slid into the dovetail groove 122. Similarly, the dovetail tongue 158 associated with the second side wall 110 can be slid into the dovetail groove 124.

As the dovetail tongues 158 are slid into the dovetail grooves 122, 124, the first and second side walls 108, 110 are moved into the desired positions. For instance, as shown in FIG. 8, the dovetail tongues 158 may be slid into the dovetail grooves 122, 124 until the grooves 118, 120 in the side walls 108, 110 are aligned with the groove 114 in the front wall 104. Once the dovetail tongues 158 have been inserted into the dovetail grooves 122, 124, the first and second side walls 108, 110 are connected to the front wall 104 via the dovetail connection components 150.

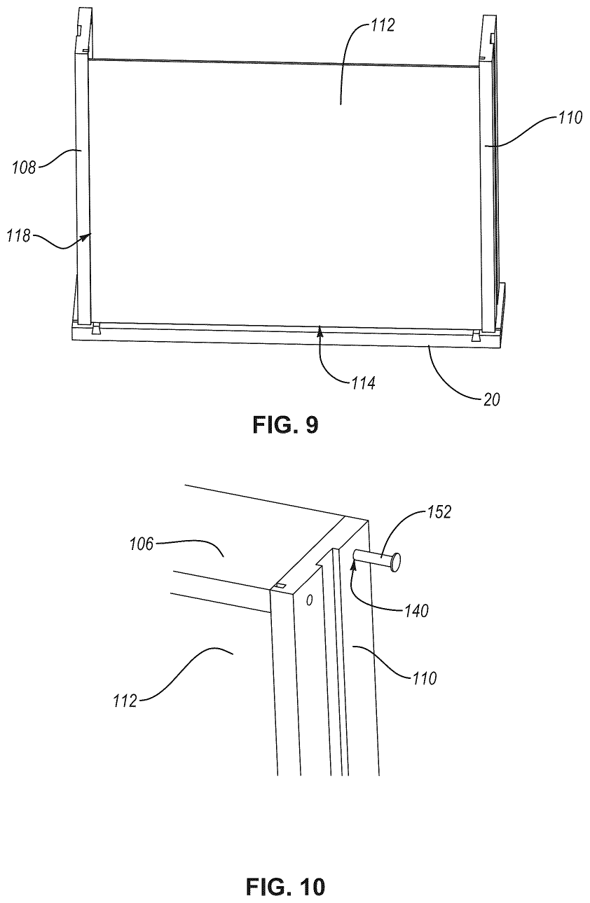

With the side walls 108, 110 connected to the front wall 104, the bottom panel 112 may be inserted into the grooves 114, 118, 120 in the front wall 104 and side walls 108, 110, as shown in FIG. 9. Thereafter, as shown in FIG. 10, the back wall 106 may be arrange between the side walls 108, 110 so the groove 116 receives an edge of the bottom panel 112 therein and so the apertures 130, 132, 138, 140 are aligned with the recesses 142, 144, 146, 148, respectively. With the apertures and recesses aligned, a pin connection components 152 may be inserted through each aperture 130, 132, 138, 140 and into the associated recess 142, 144, 146, 148. FIG. 10 illustrates a pin connection component 152 being inserted through the aperture 140 and into the recess 148.

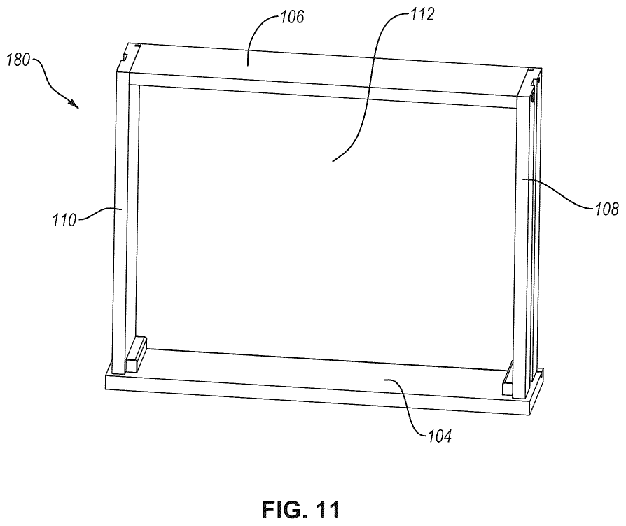

FIG. 11 illustrates a fully assembled drawer 180. In the fully assembled drawer 180, the body 154 of each of the dovetail connection components 150 is visible on the interior of the drawer 180. The heads 174 of the pin connection components 152 are visible on the exterior surfaces of the side walls 108, 110.

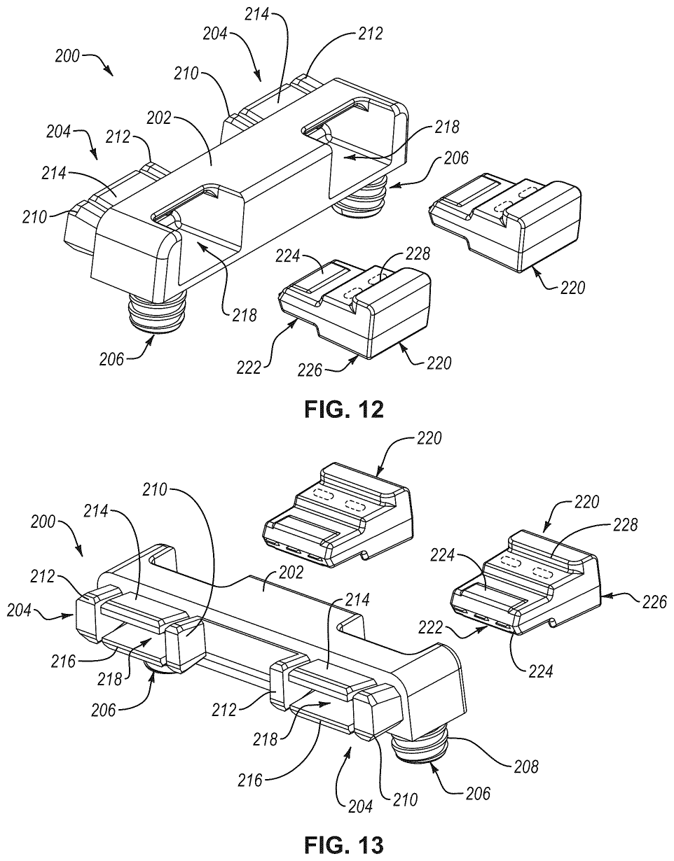

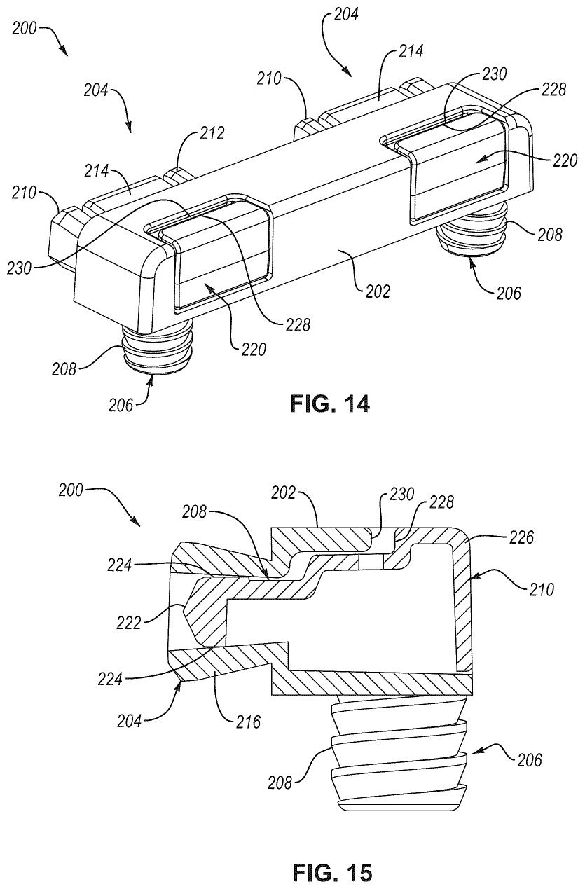

Attention is now directed to FIGS. 12-15, which illustrate an example embodiment of a dovetail connection component 200. The dovetail connection component 200 may be similar or identical to the dovetail connection component 150 in many respects, including the structure and function thereof. Accordingly, the following discussion of the dovetail connection component 200 will focus on those features thereof that may be different from the dovetail connection component 150.

The dovetail connection component 200 includes a body 202 with connection features extending from different sides thereof. The connection features can include one or more dovetail tongues 204 and one or more posts 206. In the illustrated embodiment, the one or more dovetail tongues 204 include first and second dovetail tongues 204 that are aligned with one another and spaced apart along the length of the body 202. Similarly, the one or more posts 206 include first and second posts 206 that are aligned with one another and are spaced apart along the length of the body 202.

In the illustrated embodiment, the posts 206 include ribs 208 disposed at least partially therearound and along at least a portion of the length thereof. While the ribs 179 on each of the posts 166, 168 are individual ribs that extend circumferentially around the posts 166, 168 perpendicular to the length or axis of the posts 166, 168, each of the posts 206 comprises a single rib 208 that spirals around and along at least a portion of the length the post 206. While the illustrated embodiment shows a single spiral rib 208 on each post 206, it will be appreciated that this is merely an example. In other embodiments, each post 206 may include more that one spiral rib that spiral in the same or different directions from one another and/or that extend along the same or different lengths of the posts 206.

In the illustrated embodiment, each of the dovetail tongues 204 includes end walls 210, 212 on opposing ends thereof. In some embodiments, the end walls 210, 212 are optional and may be omitted. Each dovetail tongue 204 also includes opposing first and second wings 214, 216. The first and second wings 214, 216 are spaced apart from one another and extend at least partially between the end walls 210, 212. As shown, each of the wings 214, 216 has an angled outer surface, so that the dovetail tongue 204 has a general dovetail shape. That is, the distance between the outer surfaces of the wings 214, 216 increases further away from the body 202. In other embodiments, the outer surfaces of the wings 214, 216 may be generally parallel to one another or may be angled towards one another (e.g., get closer together as they extend away from the body 202) in a natural or pre-installed state. In any case, the wings 214, 216 may be configured to flex away from one another to complete an installation, as discussed below.

In the illustrated embodiment, the wings 214, 216 are not connected directly to the end walls 210, 212. In other embodiments, portions of the wings 214, 216 (e.g., portions thereof closest to the body 202) may be connected to portions of the end walls 210, 212. Preferably, however, at least portions of the wings 214, 216 (e.g., the portions furthest from the body 202) are disconnected from the end walls 210, 212.

The dovetail connection component 200 also include one or more apertures 218 extending therethrough. In the illustrated embodiment, the dovetail connection component 200 includes an aperture 218 for each of the dovetail tongues 204. As can be seen, each aperture 218 extends through the body 202 and is aligned with one of the dovetail tongues 204. That is, each aperture 218 opens from the body 202 between or extends between the end walls 210, 212 and the wings 214, 216.

The dovetail connection component 200 further includes one or more wedges 220. The illustrated embodiment includes a wedge 220 for each of the apertures 218. Each wedge 220 includes a first end 222 that is configured to be inserted into and/or through one of the apertures 218. The first end 222 may include one or more protrusions 224. In the illustrated embodiment, the first end 222 includes a protrusion 224 on an upper surface and on a lower surface.

Each wedge 220 also includes a second end 226 opposite the first end 222. The second end 226 may include a shoulder 228. The shoulder 228 may be configured to engage a shoulder 230 or other surface on the body 202 to limit how far the wedge 220 may be inserted into the aperture 218.

As illustrated in the cross-sectional view of FIG. 15, when the wedge 220 is inserted into the aperture 218, the protrusions 224 engage the wings 214, 216 and cause the wings 214, 216 to spread further apart from one another. During assembly of a drawer or other piece of furniture, the dovetail tongues 204 can be slid into the dovetail groove in the furniture component (similar to FIG. 8). Once the dovetail tongues 204 are positioned as desired, the wedges 220 can be inserted into the apertures 218. As noted, the insertion of the wedge 220 causes the wings 214, 216 to flex outwardly away from one another. This will cause the wings 214, 216 to press against the walls of the dovetail groove, thereby increasing the friction therebetween and securely hold the dovetail tongues 204 in place within the dovetail groove.

In the event that disassembly is desired, the wedges 220 can be withdrawn from the apertures 218. To withdraw the wedges 220 from the apertures 218, a user may apply a force to the shoulders 228 of the wedge 220 in a direction away from the shoulders 230 of the body 202. The wedges 220 may also include one or more apertures 231 extending therethrough that may be used to facilitate withdrawal of the wedges 220 from the apertures 218. For instance, a tool may be inserted between the shoulders 228, 230 and into the apertures 231. The tool may then be leveraged against the shoulders 230 to move the wedges 220 out of the apertures 218. With the wedges 220 withdrawn, the wings 214, 216 can flex back closer to one another, thereby reducing the friction between the dovetail tongues 204 and the walls of the dovetail groove and allowing the dovetail tongues 204 to be slid out of the dovetail groove.

Although the illustrated and described embodiment focuses on using the connection components to secure drawer box parts together, this is merely exemplary. The disclosed connection components may be used to secure other furniture pars together. For instance, the connection components may be used to connect the parts of a cabinet shell or carcass together. The connection components may also be used to connect non-furniture related parts together.

According to one example embodiment, a connection component comprises: a body; a first connection feature extending from a first side of the body; and a second connection feature extending from a second side of the body, the second connection feature being different than the first connection feature.

In some embodiments, the first connection feature comprises one or more dovetail tongues.

In some embodiments, the one or more dovetail tongues extends along a length of the body.

In some embodiments, each of the dovetail tongues comprises opposing sides that are slanted relative to one another.

In some embodiments, the second connection feature comprises two or more second connection features.

In some embodiments, the two or more second connection features comprise first and second posts.

In some embodiments, the first and second posts are spaced apart from one another.

In some embodiments, each of the first and second posts comprise one or more ribs extending at least partially thereabout and along at least a portion of a length thereof.

In some embodiments, the first connection feature and the second connection feature extend from the body in different directions so as to form an angle of 90 degrees therebetween.

In another embodiment, a furniture kit comprises: a first wall having a dovetail groove formed therein; a second wall having one or more recesses formed therein; and a connection component having one or more dovetail tongues and one or more posts, the one or more dovetail tongues being configured for insertion into the dovetail groove to secure the connection component to the first wall, and the one or more posts being configured for insertion into the one or more recesses to secure the connection component to the second wall.

In some embodiments, the connection component comprises a body from which the one or more dovetail tongues and the one or more posts extend.

In some embodiments, the one or more dovetail tongues and the one or more posts extend from the body in different directions.

In some embodiments, the one or more dovetail tongues comprises first and second dovetail tongues that are spaced apart from one another along a length of the body.

In some embodiments, the one or more recesses comprises two spaced apart recesses and the one or more posts comprises two spaced apart posts, the two posts being spaced apart by the same distance as the two spaced apart recesses.

In some embodiments, the first wall has a second dovetail groove formed therein, the second dovetail groove being spaced apart from the dovetail groove.

In some embodiments, the furniture kits further comprises: a third wall having one or more recesses formed therein; and a second connection component having a dovetail tongue and one or more posts, the dovetail tongue being configured for insertion into the second dovetail groove to secure the connection component to the first wall, and the one or more posts being configured for insertion into the one or more recesses in the third wall to secure the second connection component to the third wall.

In some embodiments, the furniture kit further comprises a fourth wall, the fourth wall having one or more recesses in a first end thereof and one or more recesses in a second end thereof, wherein the second and third walls each have one or more apertures therethrough that are configured to be aligned with the one or more recesses in the ends of the fourth wall.

In some embodiments, the furniture kit further comprises two or more pin connection components, each of which is configured to be inserted through one of the apertures in second or third wall and into one of the recesses in the fourth wall.

In another embodiment, a connection component comprises: a body having a length and a plurality of sides; a first connection feature extending from a first side of the body and along a portion of the length of the body, the first connection feature having first and second wings that cooperate to form a dovetail profile; second and third connection features extending from a second side of the body, the second and third connection features comprising spaced apart posts; an aperture extending through the body and between the first and second wings; and a wedge configured to be inserted into the aperture and between the first and second wings to cause the first and second wings to flex away from one another.

In some embodiments, the wedge comprises one or more protrusions configured to engage at least one of the first and second wings.

In some embodiments, the first connection feature comprises end walls on opposite sides of the first and second wings.

In some embodiments, the body comprises a shoulder and the wedge comprises a shoulder, the wedge shoulder being configured to engage the body shoulder to limit how far the wedge can be inserted into the aperture.

In some embodiments, each of the spaced apart posts comprises a spiral rib extending therearound.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A connection component, comprising:
a body;
a first connection feature extending from a first side of the body; and
a second connection feature extending from a second side of the body, the second connection feature being different than the first connection feature.

2. The connection component of claim 1, wherein the first connection feature comprises one or more dovetail tongues.

3. The connection component of claim 2, wherein the one or more dovetail tongues extends along a length of the body.

4. The connection component of claim 2, wherein each of the one or more dovetail tongues comprises opposing sides that are slanted relative to one another.

5. The connection component of claim 1, wherein the second connection feature comprises two or more second connection features.

6. The connection component of claim 5, wherein the two or more second connection features comprise first and second posts.

7. The connection component of claim 6, wherein the first and second posts are spaced apart from one another.

8. The connection component of claim 6, wherein each of the first and second posts comprise one or more ribs extending at least partially thereabout and along at least a portion of a length thereof.

9. The connection component of claim 1, wherein the first connection feature and the second connection feature extend from the body in different directions so as to form an angle of 90 degrees therebetween.

10. A furniture kit, comprising:
a first wall having a dovetail groove formed therein;
a second wall having one or more recesses formed therein; and
a connection component having one or more dovetail tongues and one or more posts, the one or more dovetail tongues being configured for insertion into the dovetail groove to secure the connection component to the first wall, and the one or more posts being configured for insertion into the one or more recesses to secure the connection component to the second wall.

11. The furniture kit of claim 10, wherein the connection component comprises a body from which the one or more dovetail tongues and the one or more posts extend.

12. The furniture kit of claim 11, wherein the one or more dovetail tongues and the one or more posts extend from the body in different directions.

13. The furniture kit of claim 11, wherein the one or more dovetail tongues comprises first and second dovetail tongues that are spaced apart from one another along a length of the body.

14. The furniture kit of claim 10, wherein the one or more recesses comprises two spaced apart recesses and the one or more posts comprises two spaced apart posts, the two posts being spaced apart by the same distance as the two spaced apart recesses.

15. The furniture kit of claim 10, wherein the first wall has a second dovetail groove formed therein, the second dovetail groove being spaced apart from the dovetail groove, and the furniture kit further comprising:
a third wall having one or more recesses formed therein;
a second connection component having a dovetail tongue and one or more posts, the dovetail tongue being configured for insertion into the second dovetail groove to secure the connection component to the first wall, and the one or more posts being configured for insertion into the one or more recesses in the third wall to secure the second connection component to the third wall;
a fourth wall, the fourth wall having one or more recesses in a first end thereof and one or more recesses in a second end thereof, wherein the second and third walls each have one or more apertures therethrough that are configured to be aligned with the one or more recesses in the ends of the fourth wall; and
two or more pin connection components, each of which is configured to be inserted through one of the apertures in second or third wall and into one of the recesses in the fourth wall.

16. A connection component, comprising:
a body having a length and a plurality of sides;
a first connection feature extending from a first side of the body and along a portion of the length of the body, the first connection feature having first and second wings that cooperate to form a dovetail profile;
second and third connection features extending from a second side of the body, the second and third connection features comprising spaced apart posts;
an aperture extending through the body and between the first and second wings; and
a wedge configured to be inserted into the aperture and between the first and second wings to cause the first and second wings to flex away from one another.

17. The connection component of claim 16, wherein the wedge comprises one or more protrusions configured to engage at least one of the first and second wings.

18. The connection component of claim 16, wherein the first connection feature comprises end walls on opposite sides of the first and second wings.

19. The connection component of claim 16, wherein the body comprises a shoulder and the wedge comprises a shoulder, the wedge shoulder being configured to engage the body shoulder to limit how far the wedge can be inserted into the aperture.

20. The connection component of claim 16, wherein each of the spaced apart posts comprises a spiral rib extending therearound.
